(19) United States
(12) Patent Application Publication
(10) Pub. No.: US 2026/0221065 A1
(43) Pub. Date: Jul. 30, 2026

(54) HARDWARE WAKE FOR DISPLAY PANEL

(71) Applicant: QUALCOMM Incorporated, San Diego, CA (US)

(72) Inventors: Rui ZHANG, Shanghai (CN); Lei CHEN, Shanghai (CN); Yahui WANG, Shanghai (CN); Chunhua TANG, Shanghai (CN)

(21) Appl. No.: 19/146,474

(22) PCT Filed: Feb. 20, 2023
(86) PCT No.: PCT/CN2023/077093

§ 371 Date: Jul. 8, 2025

(51) Int. Cl. G09G 3/20; G06F 9/4401

(52) U.S. Cl. CPC G09G 3/20; G06F 9/4418; G09G 2320/0252; G09G 2330/022; G09G 2330/023; G09G 2340/0435; G09G 2354/00

(57) ABSTRACT

Aspects relate to hardware wake for a display panel. In one aspect a wakeup event is received at a system processor. The system processor wakes from an idle state to an active state. A wakeup signal is sent during the waking of the system processor at an output of the system processor. The output is configured to be coupled to a display panel. The wakeup signal is a command to the display panel to increase a frame rate of the display panel from an idle frame rate to an active frame rate.

### TECHNICAL FIELD

Aspects of the present disclosure relate generally to display panel operation and, in particular, to a hardware wake configuration to refresh the refresh rate of a display panel.

### BACKGROUND

Display panels appear on myriad portable and fixed devices. Display panels may include light emitters (e.g., a backlight or light-emitting diode elements) and a video driver, both of which consume power. The video driver generates the content, in terms of what will be seen on the display panel, and refreshes the panel at some rate, usually expressed as frames per second. The lowest power display panels have no or an intermittent backlight and slow or fixed content. This is suitable for a thermostat or an e-reader. The highest power display panels feature bright, fast moving video content, and are suitable for entertainment and content consumption.

With many devices that include display panels, there are idle or low use times and also high speed, high use times. During the slower times the frame rate of the display may be low, for example 30 or 60 frames per second (fps) or less. During the high speed times, a faster frame rate may be required. Video consumption is typically rendered at 24 to 30 fps. Computer monitors often operate at 60 fps. For video games, higher frame rates, such as 120 or 240 fps are desired. With interactive systems that respond to touch or a pointer, the frame rate directly affects the user's impression of the responsiveness of the system. At 1 fps, even typing will appear to be sluggish. At 60 fps, screen scrolling may appear slow or jittery. User interaction is significantly improved when the display panel operates at a high frame rate.

In order to conserve power, many portable devices will collapse the power consumption of the display panel by shutting it off. This eliminates power consumed by the light emitters and by the video driver. When the display is still powered, power consumption is reduced by dimming the screen, reducing the refresh rate, and repeatedly rendering the same image for each frame. With a command mode display panel, the display panel is able to operate autonomously at a specified frame rate. This eliminates some of the light emitter power and much of the power consumed by the video driver. In a mobile telephone with a large display panel, the power consumption of the device may be reduced by as much as 4% by reducing the display panel refresh rate from 120 fps to 30 fps. When the user lifts the device, touches the touchscreen, looks at a front-facing camera, or reactivates the device in another way, then the refresh rate is returned to a more satisfactory rate, such as 60 or 120 fps.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

In one example, a method includes receiving a wakeup event at a system processor, waking the system processor from an idle state to an active state, and sending a wakeup signal during the waking of the system processor at an output of the system processor. The output is configured to be coupled to a display panel. The wakeup signal is a command to the display panel to increase a frame rate of the display panel from an idle frame rate to an active frame rate.

In another example, an apparatus includes a system processor configured to receive a wakeup event. The system processor is configured to wake from an idle state to an active state in response to the wakeup event. A wakeup connector is coupled to the system processor and configured to be coupled to a display panel to send a wakeup signal to the display panel during the waking of the system processor from the idle state. The wakeup signal is a command to the display panel to increase a frame rate of the display panel from an idle frame rate to an active frame rate.

In another example, a non-transitory computer-readable medium has instructions stored therein for causing a system processor coupled to a command mode display panel to perform the operations of the method above

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 illustrates a block diagram of a system on a chip, in accordance with certain aspects of the disclosure.

FIG. 2 illustrates a block diagram of a system coupled to a command mode display panel with a hardware wakeup connector, in accordance with certain aspects of the disclosure.

FIG. 3 illustrates system wakeup timing as it relates to a command mode display panel frame refresh rate.

FIG. 4 illustrates system wakeup timing with a discrete new frame rate setting as it relates to a command mode display panel frame refresh rate, in accordance with certain aspects of the disclosure.

FIG. 5 illustrates a functional block diagram of wakeup processes, in accordance with certain aspects of the disclosure.

FIG. 6 illustrates a block diagram of an example hardware implementation for a device having a hardware wake for a command mode display panel with a processor core, a display processor unit, and a memory, among other components, in accordance with certain aspects of the disclosure.

FIG. 7 illustrates a flow diagram of a method implementing a hardware wake for a command mode display panel, in accordance with certain aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects disclosed herein provide a hardware wake configuration to resume the active refresh rate of a display panel, e.g., a command mode display panel. For many use scenarios, an idle period of use is immediately followed by an active period of use. A quicker wakeup time, also called a reduced wakeup latency, provides a more pleasant experience for the user when the device switches from a reduced power, idle, or sleep state to a fully awake or power on state. The wakeup latency is directly affected by the frame rate because the frame rate is changed at the beginning of a new frame. At 60 fps, 16 ms are required before the next frame may be refreshed. At 1 fps, 1000 ms are required to refresh a new frame. A user experiences a 1000 ms delay and even a 100 ms or 50 ms delay as poor performance. To avoid this experience a display panel may be limited to at least 60 fps even during idle periods. Some panels, e.g., Low Temperature Polycrystalline Oxide (LTPO) panels, can reach extremely low frame rates, such as 1 fps. By reducing the wakeup latency, such low power performance may be used more fully, saving power without negatively affecting the user experience.

Some devices have an active frame rate that changes depending on the particular use of the device. For relativity static activities such as reading, typing, or browsing, the command mode display panel may operate at an active frame rate of 60 fps. For active consumption activities such as rendering video, the command mode display panel may operate at an active frame rate of 120 fps. For interactive activities, such as scrolling or gaming, the command mode display panel may operate at an active frame rate of 240 fps. With increasingly higher frame rates, power demands on the device are increased. By using increasingly lower idle frame rates, such as 30, 10 or 1 fps during idle times, the overall impact of the high power demands may be compensated for.

Various aspects provide a dedicated electrical connection, e.g., using a display panel pin, between a system processor and a display panel to quickly wake up the refresh rate of the panel to an active refresh rate as the system processor, which may include a display processor unit (DPU), video controller, or other driver of the command mode display panel, is resuming its active state. The display panel refresh rate may be raised at the next opportunity after the display panel receives the pin assertion from the system processor. This may be at the start of the next video sync period, which is the start of rendering the next frame, which may be a same or different image as the previous frame. When the software resumes and is ready to generate new content, the refresh rate has already been increased. This allows for a much quicker transition to active high speed operation than waiting for the software to raise the refresh rate.

The wakeup event may be from one or multiple sources depending on the nature of the device and the use case. A touchscreen interface may generate a wakeup event if a user taps the screen to wake up the apparatus. The wakeup event may also or alternatively be from a low power digital signal processor (DSP), a video driver, or a sensor island for a device that uses an eye tracking sensor, an accelerometer, a proximity sensor, or a tilt sensor. The wakeup event provides a basis for a wakeup signal at an output of a system processor.

A wakeup signal can come from various sources within the system processor, such as a lower power processor or a DSP associated with a sensor or touch panel. The wakeup signal may also come from an application processor or display processing unit after these are awakened. A faster wake up time allows the frame rate of the command mode display panel to be switched to a much lower idle frame rate and to be switched to the idle frame rate more often. This allows the device to reduce power consumption without the disadvantage of the system latency of a typical power collapse.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects or uses may come about via integrated circuit chip examples and other non-module-component based devices (for example, end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM (Original Equipment Manufacturer) devices or systems incorporating one or more aspects of the described innovations. In some practical settings, devices incorporating described aspects and features may also necessarily include additional components and features for implementation and practice of claimed and described aspects. For example, temperature and power sensors may use a number of components for analog and digital purposes (for example, hardware components including a power supply, a transducer, a detector, an accumulator, a digital to analog converter, etc.). It is intended that innovations described herein may be practiced in a wide variety of devices, chip-level components, systems, distributed arrangements, end-user devices, etc. of varying sizes, shapes, and constitution

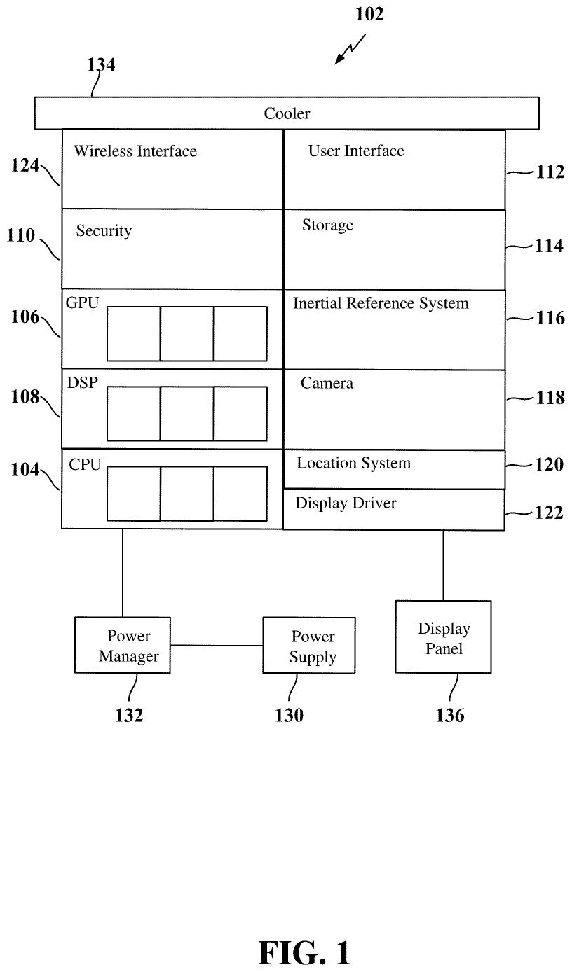

FIG. 1 is a block diagram of a system on a chip (Soc) suitable for use with a portable device or computer. The SoC 102 has multiple components on a single integrated circuit chip thermally coupled to a cooler 134, e.g., a heat spreader, and attached to a package (not shown). Alternatively, the SoC may be implemented as a system in a package (SiP) in which the components are formed on two or more different chips that are coupled together within a single package. The SoC 102 has a multiple core processor, which may include, e.g., a CPU 104 or an application processor, a multiple core graphics processor, e.g., a GPU 106, a multiple core digital signal processor, e.g., a DSP 108, and a security module 110 that provides secret keys, device security, encryption, and decryption.

The SoC 102 may also include a user interface 112 coupled to external components, such as a touchscreen, keyboard, buttons, etc. The SoC shown in FIG. 1 further includes mass storage 114, an inertial reference unit 116, a camera 118, a location system 120, such as a satellite positioning system, and a display driver 122, e.g., a display processor unit (DPU). The display driver 122 is coupled to a command mode display panel 136, e.g., a user display with a touchscreen overlay. The display driver sends new frames, and control signals, and commands the refresh rate of the command mode display panel 136. In some embodiments, the display driver 122 may be incorporated into the GPU 106. In addition, the SoC may include a wireless interface 124 that couples to analog radio frequency components and antennas (not shown) to support wireless data and control interfaces.

Each of the components is coupled through a bus (not shown) or through the CPU 104 and more or fewer components may be used to suit particular applications. As an alternative to the SoC 102, as shown, any one or more components may be manufactured on separate chips and packaged together or separately. One or more of the GPU 106, DSP 108, CPU 104, display driver 122, and mass storage 114 or a part of the mass storage 114 may be combined physically or logically to form a system processor as described further herein.

An apparatus including the SoC 102 is coupled to a power supply 130, such as a battery, or mains converter that is coupled to the SoC 102 through a power manager 132 that may be on the chip or a discrete component. The power manager 132 regulates the power of the components of the SoC 102 and controls operating clock frequencies and voltages applied to the components of the SoC 102. The power manager 132 further controls the voltage applied to the SoC and is also able to measure the battery charge level of the power supply.

The cores of the CPU 104, GPU 106, and other components, such as the mass storage 114 and wireless interface 124, among others may include or be fitted with thermal sensors and power sensors, in the form of voltage sensors, current sensors, or both. The sensors provide information to the power manager 132 for the regulation of frequency and voltage provided to the components. In some examples, the CPU 104, GPU 106, and other clocked components may also include a power manager circuit or software to determine appropriate clocking frequencies and voltages.

The power manager 132 or the CPU 104 may also control activity states of the apparatus, e.g., one or more idle states or power collapse states and one or more active states or wake states. Based on the particular state, various components of the SoC are slowed or shut down to save power and reduce heat to the cooler 134. When a wakeup event occurs, then the system resumes. The SoC may also be able to turn off certain components during certain operational modes.

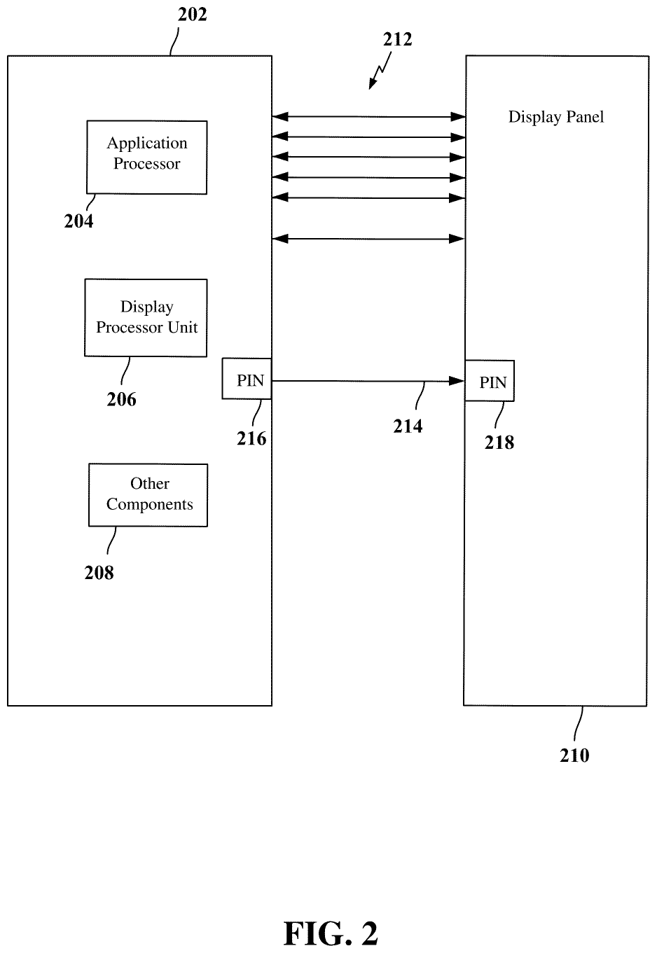

FIG. 2 illustrates a hardware block diagram of a portion of a system processor 202, e.g., an SoC, SiP, or main board, with an application processor (AP) 204, e.g., a CPU, and a display processor unit (DPU) 206, e.g., a GPU, display driver, or both, coupled to a command mode display panel with a hardware wakeup connection. The system processor 202 includes an AP 204 that is internally coupled to a DPU 206 and to other components 208. The other components 208 may include, for example, any of the components mentioned with respect to FIG. 1, including memory, power controllers, sensors, and external interfaces. The other components 208 may also include wakeup sources, such as button interfaces, touchscreen controllers, cameras, inertial reference units, external interfaces, etc. A software instruction executed by the AP 204 may also be a wakeup source. The system processor 202 has a data bus 212 to communicate with the command mode display panel 210. The data bus 212 may be any suitable data bus for carrying video frames and command and control information, e.g., mobile industry processor interface, display serial interface (MIPI DSI), inter-integrated circuit (I2C), and power connections, etc.

In addition, a wakeup connector 214 is coupled to the command mode display panel 210 from the system processor 202 to carry a wakeup signal that is sent by the system processor 202. The wakeup connector 214 may be coupled from the DPU 206, the AP 204, other components 208, e.g., a sensor island or a touch sensor, or an external source. In an example, the wakeup connector 214 is in the form of a general purpose input/output (GPIO) connector from a dedicated wakeup pin 216, e.g., a GPIO pin, of the system processor 202 to a dedicated wakeup pin 218 of the command mode display panel 210. The dedicated wakeup pin 216 sets the signal as high or low or another signal format generated by a suitable signal source of the system processor. In an example, the wakeup signal source sets the wakeup signal at the dedicated wakeup pin 216 of the system processor as e.g., HI or LO which is coupled through the wakeup connector 214 to set the corresponding dedicated wakeup pin 218 of the display panel as HI or LO. In another example, a wakeup signal is sent as a multiple bit command or a control packet through the wakeup connector 214 which be dedicated to the wakeup signal only or which may also carry other command and control signals.

While the wakeup connector 214 is shown as a single wire, the wakeup signal may be carried on a bus that provides for quick low data rate communication, e.g., I2C. A more complex bus may be used to command the command mode display panel 210 to change to a specific refresh rate for the next wakeup sequence. The system processor 202 and the command mode display panel 210 may contain many more components. These components are not shown here in order to simplify the description. The wakeup connector 214 is independent of the data bus 212 that carries data, command, control, and new frames to the command mode display panel 210. As a result, the wakeup signal is independent of any frame and independent of any current or pending frame rate of the command mode display panel 210. The wakeup signal may be sent independent of and parallel with any activity on the video bus.

In other examples, a wakeup event may be caused by eye tracking at an eye sensor of a sensor island. In this example, the wakeup connector may be coupled between the eye sensor and the command mode display panel 210. An eye sensor DSP may be configured to generate a wakeup signal after a detected gaze behavior generates a wakeup event. In another example, a touchscreen integrated circuit (IC) may be coupled to the wakeup connector so that after firmware in the touchscreen IC detects a wakeup event, a wakeup signal may be generated and sent to the command mode display panel. In another example an accelerometer detects tilting or raising as a wakeup event. An inertial reference unit IC may be coupled to the wakeup connector so that the firmware in the inertial reference unit IC generates a wakeup signal. In another example, multiple sensors are connected the same wakeup pin of the command mode display panel and any one of the sensors may generate the wakeup signal. In such examples the wakeup signal is independent of the AP and DPU.

When the apparatus, including the system processor 202 and the command mode display panel 210 is idle and there is no new content to show on the command mode display panel 210, then the AP and the DPU may be power collapsed into a power collapse state, an idle state, or another low power state to reduce power consumption. The command mode display panel may still be powered and perform a self-refresh of its display. A significant power savings is obtained by reducing the frame rate of the display during the power collapse. The lower the frame rate, the greater the power savings. In some scenarios, an active frame rate is between 60 and 240 frames per second (fps) while a reduced speed idle frame rate may be between 1 and 30 fps.

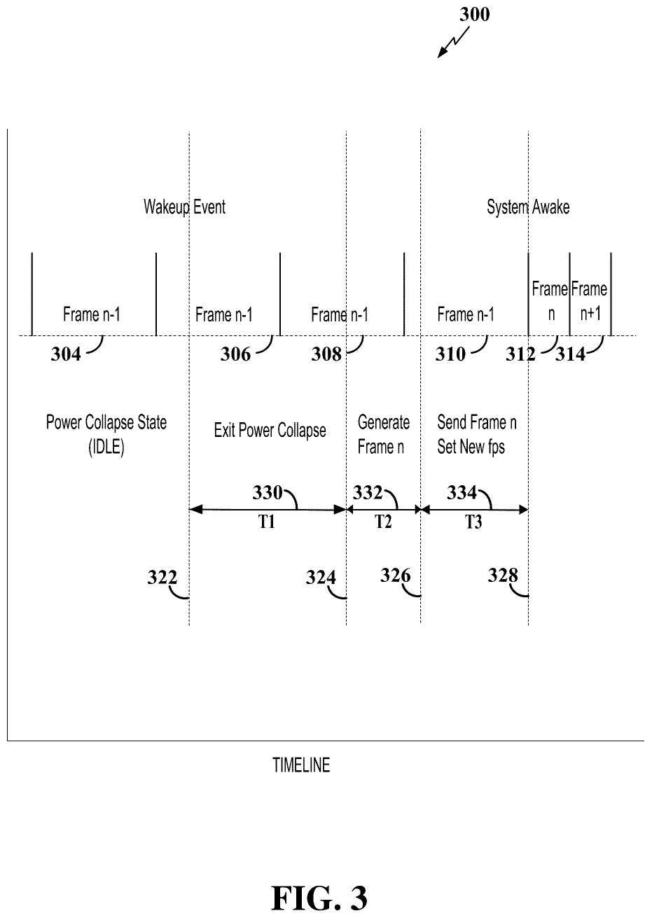

FIG. 3 is a diagram of system wakeup timing 300 as it relates to a command mode display panel frame refresh rate. The top of the diagram shows a sequence of video sync periods across a timeline. Six video sync periods are shown in time sequence from left to right each refreshing the display of a frame. There are earlier video sync periods not shown to the left and later video sync periods not shown to the right. At the left in the timeline of the diagram, the apparatus is in a power collapse state or idle state. The command mode display panel has been set to a low frame rate and repeatedly refreshes the same frame, Frame n−1. This may be a self-refresh mode of a command mode display panel that is active when the AP and DPU are idle. During a first video sync period 304, the command mode display panel shows a frame numbered Frame n−1. During a second video sync period 306, the command mode display panel shows the same frame, Frame n−1, again. This same frame is shown in the third video sync period 308 and the fourth video sync period 310.

In this example, a wakeup event is received at time 322 during the second video sync period. This causes the system processor, e.g., an AP and DPU, to exit the power collapse state and to wake to an active state. The wakeup event may be a touch of a power key or other key, a touchscreen controller touch, an inertial reference sensor event, such as a tilt or acceleration, a camera detection, proximity sensor detection, or other event. The wakeup event may come from a sensor island, touchscreen controller, inertial reference unit and is received at the system processor. This causes the system processor to start an exit power collapse process at time 322.

The power collapse exit requires some time to execute. The time duration of the power collapse exit is indicated as T1 and the span of T1 across the timeline along the horizontal axis is shown by arrow 330. The end of the arrow 330 is indicated as a time 324. With the AP and DPU now active, the system processor is able to begin acting on the wakeup event by refreshing the video display with a new frame, Frame n. First, after the power collapse exit of T1, the system processor generates a new frame for the command mode display panel. Generating the new frame, Frame n, requires a time duration of T2 and is shown by a second arrow 332 between time 324 and 326. Once a new frame is generated by the DPU or other video device, the apparatus waits for a time duration of T3, indicated by the third arrow 334 between the time 326 and 328, until the start of the next video sync period 312 and then sends the new frame, Frame n, to the command mode display panel.

The total time from the wakeup event to the new frame being presented on the command mode display panel is the sum of T1, T2, and T3. In some examples, T1 may be more than 100 ms. T2 may be less than the duration of a frame at a high frame rate, e.g., less than 1/120 seconds or less than 8 ms. T3 depends on the frame rate and is longer for a lower frame rate. At a frame rate of 1 fps, T3 may be as long as 1000 ms. As shown, a faster frame rate at time 326 allows for the display panel to be refreshed more quickly. However, a slower frame rate reduces the power drawn by the display panel.

Considering the example of FIG. 3, the wakeup event occurs at time 322 during the second video sync period 306. The time T1 to exit the power collapse ends at time 324 during the third video sync period 308. The time T2 to generate the next frame ends at time 326 during the fourth video sync period 310. The time T3 to send the new frame ends at a time 328 that is determined by the end of the fourth video sync period 310 which is the current period. The apparatus then sends the new frame and sets a new faster fps or active frame rate at time 328. This causes the command mode display panel to display the new frame, Frame n, during the fifth video sync period 312. At the sixth video sync period 314, a new frame, Frame n+1, may be sent by the active apparatus. The sequence of video frames may continue with the same or new frames at the new faster frame rate until the next power collapse.

Using a software system through an AP, DPU or similar component, the frame rate cannot be refreshed until after the apparatus exits the power collapse state at time 324 and also generates a frame rate command at time 326. With the apparatus active, a frame and new frame rate may be generated and sent to the command mode display panel. The transition occurs at the end of the current frame to start the next frame. At a very low frame rate, such as 1 fps, a user will perceive the device to be unresponsive because it will take more than a second for the apparatus to respond with a new frame. In the illustrated example, more than two video sync periods elapse before the apparatus responds. In order to avoid this slow response, the frame rate is kept at a higher speed, e.g., 24, 30, or 60 fps. However, more power is required to self-refresh the command mode display panel at the faster rate. During an idle time, the faster frame rate has no benefit to the user. This is in part because the device is not being actively used and in part because the frames are the same regardless of the refresh rate.

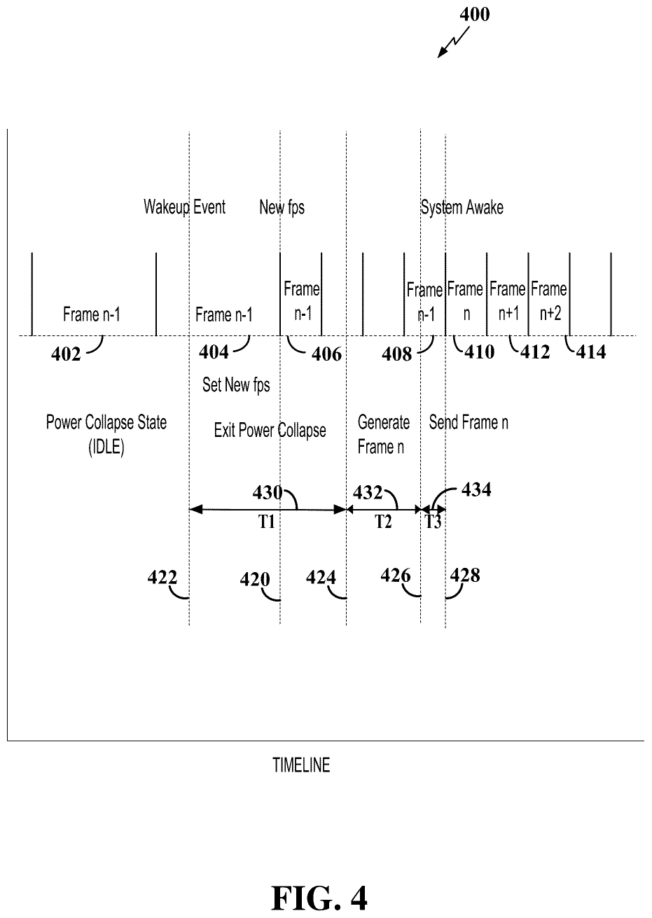

FIG. 4 is a diagram of system wakeup timing 400 using a hardware wake as it relates to a command mode display panel frame refresh rate. At the left in the diagram, the apparatus is in a power collapse state, an idle state, or any other suitable low power state. The command mode display panel has been set to an idle frame rate and repeatedly refreshes the same frame. During a first video sync period 402, the command mode display panel shows a frame numbered Frame n−1. During a second video sync period 404, the command mode display panel shows the same frame, Frame n−1, again. This same frame is shown in the third video sync period 406, the fourth, the fifth, and the sixth video sync period 410.

In this example, a wakeup event is received at time 422 at the system processor during the second video sync period. This causes the system processor, e.g., an AP and DPU, to begin a power collapse exit and return to an active state at time 424. The time duration of the power collapse exit, T1, is the same as in FIG. 3 and is controlled by the configuration of the AP and DPU and configuration of the idle state before time 422. The time duration is indicated as T1 and the span across the timeline from time 422 to time 424 along the horizontal axis is shown by arrow 430. At time 424, the apparatus is active and generates a new frame for the command mode display panel. The new frame, Frame n, requires a time duration of T2 to be generated and is shown by a second arrow 432 between time 424 and 426.

When the wakeup event occurs, there is a signal to the system processor to wake the AP and DPU. There is also a wakeup signal to the command mode display panel. The wakeup signal may be provided by a dedicated wakeup pin of the system processor to a wakeup connector that is dedicated to this purpose to a wakeup pin of a command mode display panel. The wakeup signal may also be provided in another way that is separate from the wakeup to the AP and DPU. The wakeup event may come from a sensor island, touchscreen controller, inertial reference unit or any other component that is directly or indirectly coupled to the command mode display panel. The sensor may be coupled to the command mode display panel directly or through a DSP or other controller that receives and acts on signals from the sensor. The sensor may be coupled to the system processor or be a part of the system processor and operate as a portion of the system processor that is not in a power collapse state.

The hardware wakeup signal causes the command mode display panel to switch to a faster frame rate at the end of the current video sync period, i.e., the second video sync period 404. The current video sync period is the video sync period during which the wakeup signal is sent. In this example, the wakeup event is received during the second video sync period 404 so that the third video sync period 406 is at the new faster active frame rate. The same frame, Frame n−1, is repeated at each video sync period until the next frame, Frame n, is generated during the time duration T2 indicated by the second arrow 432. The frame rate is changed at the start of the third video sync period at time 420. This is before the end of the power collapse exit at time 424 and before the generation of the next frame is completed at time 426. The specific timing of the power collapse exit and the new frame generation relative to particular video sync periods may vary depending on the idle frame rate, the active frame rate and time at which the wakeup event occurs. The change in the refresh rate from the idle frame rate to the active frame rate may be accomplished by the command mode display panel in parallel with the system collapse exit and independent of the system collapse exit, so that the system collapse exit is not affected.

Once a new frame is generated by the DPU or other video device, the apparatus waits for a time duration of T3, indicated by the third arrow 434 between the time 426 and 428, until the start of the next video sync period 410 and then sends the new frame, Frame n, to the command mode display panel. The new frame is shown in the seventh video sync period 410, and subsequent new frames are shown on the command mode display panel in the subsequent video sync periods 412, 414, etc. Some of the new frames may be copies of Frame n, depending on the particular activity of the device.

As shown for Frame n−1, the command mode display panel is able to self-refresh the display using the same frame for each video sync period. It can also change the frame rate for self-refresh in response to a command from the system processor as shown for video sync period 406 and video sync period 408. Each frame represents an image when it is rendered on the display. Accordingly, when the command mode display panel repeats the rendering of Frame n−1, it repeatedly displays a same image at the idle frame rate. The display image is static. It then repeatedly displays the same image at the active frame rate starting with video sync period 406 through video sync period 408. When the system processor provides a new frame, Frame n, this may cause the display of a new image or of the same image again for a static image display until there is new information to present on the display from the system processor for a dynamic image display.

The total time from the wakeup event to the new frame, Frame n, being presented on the command mode display panel is the sum of T1, T2, and T3. T1 and T2 are the same as in FIG. 3 because they are determined by the configuration of the apparatus, the condition of the idle state and the configuration of the active state of the AP and DPU. T3 depends on the frame rate and is much shorter than in the example of FIG. 3 because the frame rate has already been increased to an active frame rate. By changing the frame rate from 1 fps or 1000 ms to 120 fps or 8.3 ms, during the power collapse exit time duration T1 or the frame generation time duration T2, T3 may be reduced by as much as 991.3 ms. By changing the frame rate from an idle rate of 10 fps or 100 ms, T3 may be reduced by as much as 91.3 ms.

By augmenting the software system with a hardware wake, the frame rate can be refreshed to an active frame rate before the system processor exits the power collapse state. With the system processor active, a frame may be generated and sent to the command mode display panel while the command mode display panel is already at the active frame rate. The transition occurs at the end of a current frame to start a next frame. This allows the system processor to be idled at a much lower frame rate, such as 1 fps, because the frame rate will be increased before the user will perceive the device to be unresponsive. This allows a better user experience with a lower power idle state.

The timelines in the illustrated examples are not necessarily to scale. The idle frame rate, e.g., 404, is shown as only approximately three times longer than the active frame rate, e.g., 406. Such a scenario is possible with an idle frame rate of 20 fps and an active frame rate of 60 fps. While the structures and methods may be applied to such a scenario, they may also be applied to a scenario in which the difference between the idle frame rate and the active frame rate is much greater, e.g., 10 fps and 120 fps, or 1 fps and 240 fps. The timeline of FIG. 4 shows that the command mode display panel frame rate is changed at the start of the next video sync period after the wakeup signal is received. This may be during T1 or T2. This earlier change to the active refresh rate reduces the duration of T3. In other examples, the command mode display panel frame rate may be changed at the start of a second later video sync period after the wakeup signal is received. This may still cause the duration of T3 to be decreased, depending on the relative frame rates and the durations of T1 and T2.

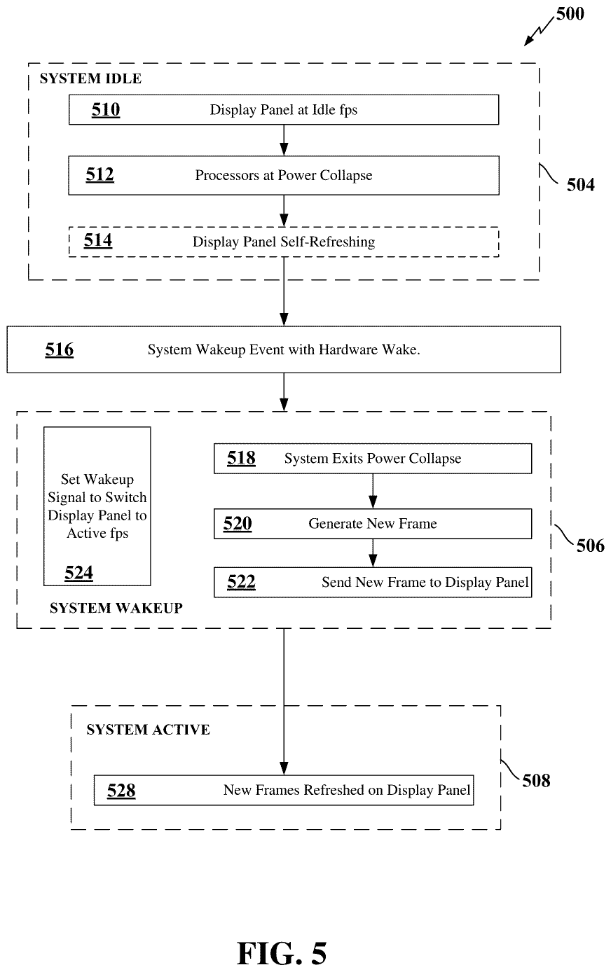

FIG. 5 is a functional block diagram of wakeup processes implemented by components of the apparatus as described above. In the wakeup processes 500, there are system idle processes 504, system wakeup processes 506, and system active processes 508. A system wakeup event 516 occurs between the system idle processes 504 and the system wakeup processes 506.

During the system idle processes 504, the command mode display panel is at an idle fps or frame rate at 510. This is a low frame rate for power conservation. The processors are at power collapse at 512, e.g., an idle state, and the command mode display panel is optionally self-refreshing at 514. With the system processor, e.g., an AP and DPU, at power collapse, no new content is being generated. The image on the display screen is static or unchanging. The display panel repeatedly displays a same image at the idle frame rate. However, with many display screen systems, the display screen must be refreshed to show the same image. At a further idle state, the command mode display screen is off. In an alternative example all of the operations described herein may be started when the command mode display screen is off during the system idle processes 504.

A system wakeup event occurs at 516. The system wakeup event generates a software command to wake the software system processors, e.g., an AP and DPU, and a hardware wake, e.g., a wakeup signal to the command mode display panel or other similar component.

The system wakeup event is provided to the system wakeup processes 506. The system wakeup processes include the apparatus exiting a power collapse state at 518. This is followed by generating a new frame at 520 which is followed by sending the newly generated frame to the command mode display panel at 522. In parallel, there is also a process to send a wakeup signal at 524 during the power collapse state exit 518. The wakeup signal is sent via a wakeup connector coupled to the command mode display panel. The wakeup signal is a command to switch the command mode display panel to an active frame rate. With the parallel processes, the command mode display panel may already be switched at 524 and operating at an active frame rate before sending a new frame to the command mode display panel at 522.

The apparatus then operates the system active processes at 508. Among these is the new frame being refreshed on the command mode display panel at 528. During the system active processes at 508, the frames may change to suit the use scenario and different active frame rates may be used to suit different use scenarios. At a later time, the apparatus returns to the system idle processes at 504 until a next system wakeup event with hardware wake at 516.

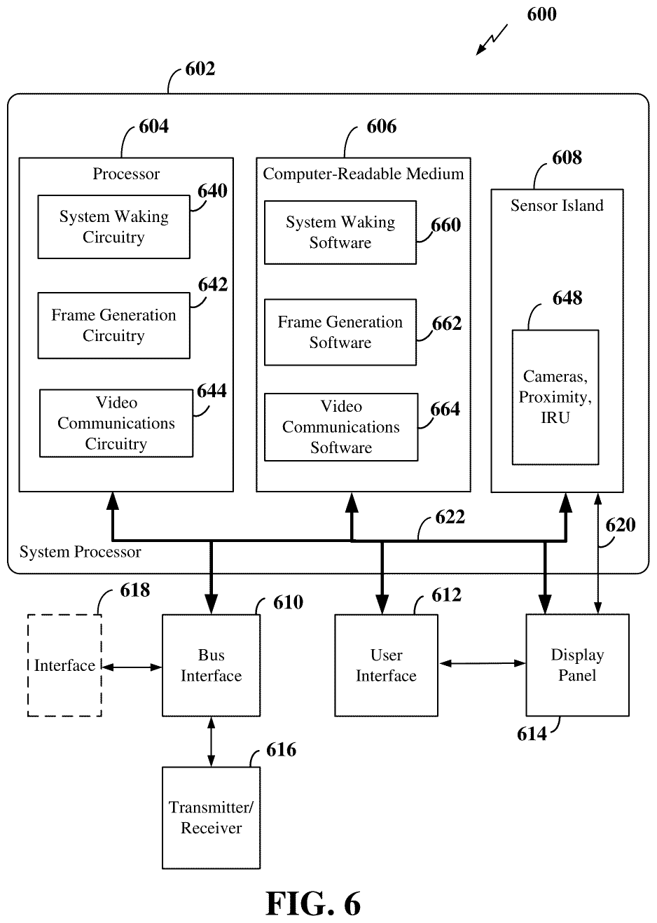

FIG. 6 illustrates a block diagram of an example of a hardware implementation for a device 600, such as a user equipment, a portable device, a notebook computer, a tablet, a computer, a server, a projector, an entertainment device, a gaming handheld, or any other suitable device with a command mode display unit and idle states. In this example, a command mode display panel 614 is capable of different refresh rates and may also be capable of self-refreshing a static image in one or more states. A system processor 602 drives the command mode display panel 614 through a bus 622 to display frames of a video source. In accordance with various aspects of the disclosure, an element, or any portion of an element, or any combination of elements may be implemented with the system processor 602. The system processor 602 may include a processor 604. Examples of the processor 604 include an AP and a DPU separately or together in the form of and also working together with microprocessors, microcontrollers, digital signal processors (DSPs), field programmable gate arrays (FPGAs), programmable logic devices (PLDs), state machines, gated logic, discrete hardware circuits, and other suitable hardware that includes processing circuitry configured to perform one or more of the functions described herein including the functions of an application processor and display processing unit.

In this example, the system processor 602 may be implemented with a bus architecture, represented generally by the bus 622. The bus 622 may include any number of interconnecting buses and bridges depending on the specific application of the system processor 602 and the overall design constraints. The bus 622 communicatively couples together various circuits including one or more processors (represented generally by the processor 604, computer-readable media (represented generally by the computer-readable medium 606) having instructions stored thereon, and a sensor island 608 that may include one or more cameras, proximity sensors, inertial reference units (IRU) and any other sensor components. The bus 622 may also link various other circuits such as timing sources, peripherals, voltage regulators, and power management circuits, which are well known in the art, and therefore, will not be described any further.

A bus interface 610 provides an interface between the bus 622 and a radio shown as a transmitter/receiver 616 and between the bus 622 and an interface 618. The transmitter/receiver 616 provides a communication interface or means for communicating over one or more wireless transmission media. The interface 618 provides a communication interface or means of communicating with various other apparatuses and devices (for example, other devices housed within the same apparatus or other external apparatus) over an internal bus or external transmission medium, such as an Ethernet cable. The bus 622 is also coupled to a user interface 612, e.g., keypad, display, speaker, microphone, joystick, etc. The user interface 612 is also optionally coupled to the command mode display panel for a touchscreen overlay.

The processor 604 is responsible for managing the bus 622 and general processing, including the execution of software stored on the computer-readable medium 606. The software, when executed by the processor 604, causes the system processor 602 to perform the various functions described below for any particular apparatus. The computer-readable medium 606 and the memory 608 may also be used for storing data that is manipulated by the processor 604 when executing software.

The processor 604 may be a part of one or more processor cores of the system processor 602 and perform operations by means of a processor core executing software stored in the computer-readable medium 606 using its processing resources. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The processor 604 performs operations performed by the system processor of FIG. 1 or 2 and as shown in the states of the wakeup processes 500 of FIG. 5.

The computer-readable medium 606 may be a non-transitory computer-readable medium. A non-transitory computer-readable medium includes, by way of example, a magnetic storage device (for example, hard disk, floppy disk, magnetic strip), an optical disk (for example, a compact disc (CD) or a digital versatile disc (DVD)), a smart card, a flash memory device (for example, a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the system processor 602, external to the system processor 602, or distributed across multiple entities including the system processor 602. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall apparatus.

The device 600 may be configured to perform any one or more of the operations described herein. In some aspects of the disclosure, the processor 604, as utilized in the device 600, may include circuitry configured for various functions.

The processor 604 may include system waking circuitry 640 to wake the processor 604 from an idle state in response to a wakeup event. The system waking circuitry 640 may include one or more hardware components that provide the physical structure that performs various processes related to waking the processor 604 from an idle state to an active state. The system waking circuitry 640 may also include functionality for transitioning the processor from an active state to an idle state. The system waking circuitry 640 may further be configured to execute system waking software (instructions) 660 included on the computer-readable medium 606 to implement the apparatus waking described herein.

The processor 604 may include frame generation circuitry 642 configured to generate a new frame when the processor is in an active state for use by the command mode display panel 614 as discussed herein. The frame generation circuitry 642 may further be configured to execute frame generation software (instructions) 662 included on the computer-readable medium 606 to implement the frame generation function described herein.

The system processor 602 processor 604 may include video communications circuitry 644 configured to perform operations of sending a new frame from the system processor 602 to the command mode display panel 614 after setting the wakeup signal to the command mode display panel 614 through the bus 622 as discussed herein. The video communications circuitry 644 may further be configured to execute video communications software (instructions) 664 included on the computer-readable medium 606 to implement one or more functions described herein.

In addition to the bus 622 and the user interface 612, the command mode display panel is also connected directly through a wakeup connector 620. The wakeup connector is shown as connected to the sensor island 608 of the system processor 602 but may also be connected to the processor 604 of the system processor 602 or other idle state management circuitry. The wakeup connector 620 is a dedicated hardware connector to carry a wakeup signal directly to the command mode display panel 614 during waking the system processor 602. The wakeup signal is a command to the command mode display panel 614 to increase a frame rate of the command mode display panel 614 to an active frame rate. In response to the wakeup signal, the command mode display panel 614 is configured to increase a frame rate of the command mode display panel from the idle frame rate to the active frame rate independent of the system processor state without any need for communications through the bus 622.

The circuit architecture described herein may be implemented on one or more ICs, analog ICs, RFICs, mixed-signal ICs, ASICs, printed circuit boards (PCBs), electronic devices, etc. The circuit architecture described herein may also be fabricated with various process technologies such as complementary metal oxide semiconductor (CMOS), NMOS, PMOS, bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the circuits described herein may be a stand-alone device or may be part of a larger device. A device may be (i) a stand-alone IC, (ii) a set of one or more ICs that may include memory ICs for storing data and/or instructions, (iii) a radio frequency integrated circuit (RFIC) such as an RF receiver (RFR) or an RF transmitter/receiver (RTR), (iv) ASICs such as a mobile station modem (MSM), (v) a module that may be embedded within other devices, (vi) a receiver, cellular phone, wireless device, handset, or mobile unit, (vii) etc.

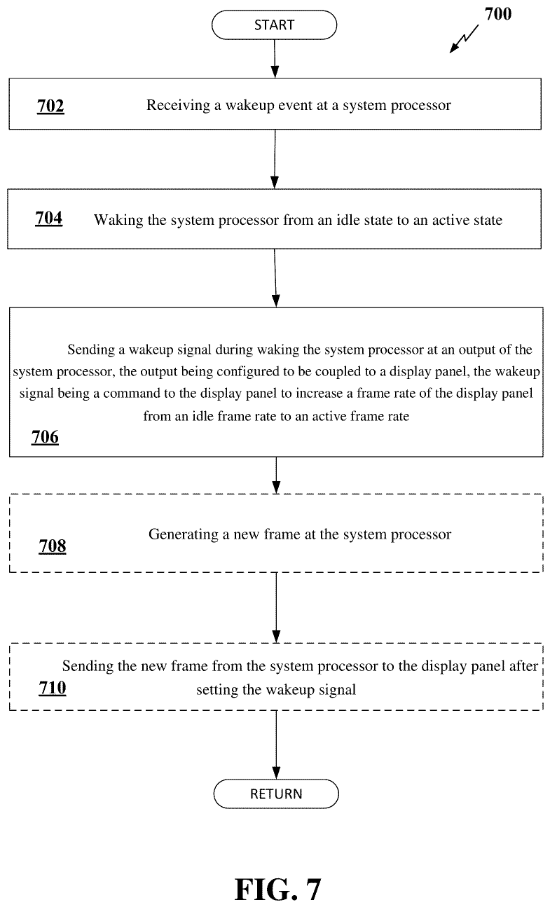

FIG. 7 is a process flow diagram illustrating an example of a method for hardware wake for a command mode display panel, such as the command mode display panel 210 of FIG. 2. The method may be performed by a system processor of FIG. 1 or 2 in the manner shown in FIG. 4 to accomplish the states of FIG. 5.

The method begins in block 702 with receiving a wakeup event at a system processor. The wakeup event may be received as an input from at least one of a camera, a button, or an inertial reference system and receiving the wakeup event is in response to receiving the input.

In block 704 waking the system processor from an idle state to an active state is performed. The system processor may be in a power collapse state or any other type of idle or low power state.

In block 706 the method continues with sending a wakeup signal during waking the system processor. The wakeup signal is sent at an output of the system processor, the output being configured to be coupled to a command mode display panel. The wakeup signal is a command to the command mode display panel to increase a frame rate of the command mode display panel from an idle frame rate to an active frame rate. In some aspects, sending the wakeup signal is performed by setting a level on a pin of the system processor that is coupled to a hardware connection between the system processor and the display panel. In some aspects, the display panel is a command mode display panel and sending the wakeup signal includes setting a general purpose input/output pin of a command mode interface of the display panel through the hardware connection. Sending the wakeup signal may be performed independent of and parallel with waking the system processor.

In some aspects, the display panel is in an idle state with the idle frame rate before receiving the wakeup signal. In some aspects, the display panel repeatedly displays a same image at the idle frame rate.

In optional block 708 generating a new frame at the system processor is performed. Generating the new frame is performed in some aspects by a display processor unit of the system processor and the sending the new frame comprises sending the new frame from the display processor unit.

In optional block 710 sending the new frame from the system processor to the command mode display panel after setting the wakeup signal is performed.

As used herein, “or” is intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the examples of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall apparatus.

The various illustrative logical blocks, modules, and circuits described in connection with the exemplary aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

In one or more exemplary aspects, the functions described may be implemented in hardware, software, firmware, or any combination thereof. If implemented in software, the functions may be stored on or transmitter over as one or more instructions or code stored on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM EEPROM, CD-ROM or other optical disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various components in the implementations described above should not be understood as requiring such separation in all implementations, and it should be understood that the described program components and systems can generally be integrated together in a single software product or packaged into multiple software products.

The following provides an overview of examples of the present disclosure.

Example 1: A method comprising: receiving a wakeup event at a system processor; waking the system processor from an idle state to an active state; and sending a wakeup signal during the waking of the system processor at an output of the system processor, the output being configured to be coupled to a display panel, the wakeup signal being a command to the display panel to increase a frame rate of the display panel from an idle frame rate to an active frame rate.

Example 2: The method of example 1, further comprising: generating a new frame at the system processor; and sending the new frame from the system processor to the display panel after sending the wakeup signal.

Example 3: The method of example 2, wherein the generating the new frame is performed by a display processor unit of the system processor and wherein the sending the new frame comprises sending the new frame from the display processor unit.

Example 4: The method of any one or more of examples 1 to 3, wherein the display panel is in an idle state with the idle frame rate before the receiving the wakeup signal.

Example 5: The method of example 4, wherein the display panel repeatedly displays a same image at the idle frame rate.

Example 6: The method of any one or more of examples 1 to 5, further comprising receiving an input from at least one of a camera, a button, or an inertial reference system and wherein the receiving the wakeup event is in response to the receiving the input.

Example 7: The method of any one or more of examples 1 to 6, wherein the sending the wakeup signal comprises setting a level on a pin of the system processor that is coupled to a hardware connection between the system processor and the display panel.

Example 8: The method of example 7, wherein the display panel comprises a command mode display panel and wherein sending the wakeup signal comprises setting a general purpose input/output pin of a command mode interface of the display panel through the hardware connection.

Example 9: The method of any one or more of examples 1 to 8, wherein the sending the wakeup signal is performed independent of and parallel with the waking the system processor.

Example 10: The method of any one or more of examples 1 to 9, wherein the idle state of the system processor is a power collapse state.

Example 11: An apparatus comprising: a system processor configured to receive a wakeup event, the system processor configured to wake from an idle state to an active state in response to the wakeup event; and a wakeup connector coupled to the system processor and configured to be coupled to a display panel to send a wakeup signal to the display panel during the waking of the system processor from the idle state, the wakeup signal being a command to the display panel to increase a frame rate of the display panel from an idle frame rate to an active frame rate.

Example 12: The apparatus of example 11, wherein the system processor is further configured to generate a new frame and to send the new frame to the display panel after sending the wakeup signal.

Example 13: The apparatus of example 12, wherein the system processor comprises a display processor unit wherein the display processor unit is configured to generate the new frame.

Example 14: The apparatus of any one or more of examples 11 to 13, wherein the system processor comprises an application processor and a display processor unit.

Example 15: The apparatus of any one or more of examples 11 to 14, wherein the display panel is in an idle state with the idle frame rate before increasing the frame rate.

Example 16: The apparatus of any one or more of examples 11 to 15, wherein the system processor is configured to avoid generating new frames in the idle state.

Example 17: The apparatus of any one or more of examples 11 to 16, further comprising at least one of a camera, a button, or an inertial reference system, and wherein the wakeup event is in response to an input from at least one of the camera, the button, or the inertial reference system.

Example 18: The apparatus of any one or more of examples 11 to 17, wherein the wakeup connector is coupled to a dedicated pin of the system processor and wherein sending the wakeup signal comprises setting a level on the dedicated pin of the system processor between the system processor and the display panel.

Example 19: The apparatus of example 18, wherein the dedicated pin is a general purpose input/output pin.

Example 20: The apparatus of any one or more of examples 11 to 19, wherein the idle state of the system processor is a power collapse state.

Example 21: A non-transitory computer-readable medium having instructions stored therein for causing a system processor coupled to a command mode display panel to perform operations comprising: receiving a wakeup event at the system processor; waking the system processor from an idle state to an active state; and sending a wakeup signal during the waking of the system processor at an output of the system processor, the output being configured to be coupled to a display panel, the wakeup signal being a command to the display panel to increase a frame rate of the display panel from an idle frame rate to an active frame rate.

Example 22: The medium of example 21, wherein the sending the wakeup signal comprises setting a level on a pin of the system processor that is coupled to a hardware connection between the system processor and the display panel.

Example 23: The medium of example 21 or 22, wherein sending the wakeup signal is performed before generating a new frame at the system processor.

1. A method comprising:
receiving a wakeup event at a system processor;
waking the system processor from an idle state to an active state; and
sending a wakeup signal during the waking of the system processor at an output of the system processor, the output being configured to be coupled to a display panel, the wakeup signal being a command to the display panel to increase a frame rate of the display panel from an idle frame rate to an active frame rate.

2. The method of claim 1, further comprising:
generating a new frame at the system processor; and
sending the new frame from the system processor to the display panel after sending the wakeup signal.

3. The method of claim 2, wherein the generating the new frame is performed by a display processor unit of the system processor and wherein the sending the new frame comprises sending the new frame from the display processor unit.

4. The method of claim 1, wherein the display panel is in an idle state with the idle frame rate before the receiving the wakeup signal.

5. The method of claim 4, wherein the display panel repeatedly displays a same image at the idle frame rate.

6. The method of claim 1, further comprising receiving an input from at least one of a camera, a button, or an inertial reference system and wherein the receiving the wakeup event is in response to the receiving the input.

7. The method of claim 1, wherein the sending the wakeup signal comprises setting a level on a pin of the system processor that is coupled to a hardware connection between the system processor and the display panel.

8. The method of claim 7, wherein the display panel comprises a command mode display panel and wherein sending the wakeup signal comprises setting a general purpose input/output pin of a command mode interface of the display panel through the hardware connection.

9. The method of claim 1, wherein the sending the wakeup signal is performed independent of and parallel with the waking the system processor.

10. The method of claim 1, wherein the idle state of the system processor is a power collapse state.

11. An apparatus comprising:
a system processor configured to receive a wakeup event, the system processor configured to wake from an idle state to an active state in response to the wakeup event; and
a wakeup connector coupled to the system processor and configured to be coupled to a display panel to send a wakeup signal to the display panel during the waking of the system processor from the idle state, the wakeup signal being a command to the display panel to increase a frame rate of the display panel from an idle frame rate to an active frame rate.

12. The apparatus of claim 11, wherein the system processor is further configured to generate a new frame and to send the new frame to the display panel after sending the wakeup signal.

13. The apparatus of claim 12, wherein the system processor comprises a display processor unit wherein the display processor unit is configured to generate the new frame.

14. The apparatus of claim 11, wherein the system processor comprises an application processor and a display processor unit.

15. The apparatus of claim 11, wherein the display panel is in an idle state with the idle frame rate before increasing the frame rate.

16. The apparatus of claim 11, wherein the system processor is configured to avoid generating new frames in the idle state.

17. The apparatus of claim 11, further comprising at least one of a camera, a button, or an inertial reference system, and wherein the wakeup event is in response to an input from at least one of the camera, the button, or the inertial reference system.

18. The apparatus of claim 11, wherein the wakeup connector is coupled to a dedicated pin of the system processor and wherein sending the wakeup signal comprises setting a level on the dedicated pin of the system processor between the system processor and the display panel.

19. The apparatus of claim 18, wherein the dedicated pin is a general purpose input/output pin.

20. The apparatus of claim 11, wherein the idle state of the system processor is a power collapse state.

21-23. (canceled)
